(19) United States
(12) Patent Application Publication
(10) Pub. No.: US 2008/0053289 A1
(43) Pub. Date: Mar. 6, 2008

(54) Dobro type guitar with soundbox extension in place of a neck

(76) Inventor: Harvard Jasper Bryan, Magnolia, AR (US)

Correspondence Address: HARVARD J. BRYAN, 920 HIGHLAND DRIVE, MAGNOLIA, AR, 71753, US

(21) Appl. No.: 11/516,260

(22) Filed: Sep. 6, 2006

(51) Int. Cl. G10D 3/00

(52) U.S. Cl. 84/291

(57) ABSTRACT

This will explain things about the conventional dobro that causes this invention to be a logical improvement over conventional dobros. Conventional dobros have a fingerboard that is not used as a fingerboard and frets that are not used as frets, lines drawn across the board in place of frets will serve the same purpose as frets, and the cost is considerably less. The neck of conventional dobros is not used as a neck to grasp with the hand and pull the strings down with the fingers against the frets to make musical notes as it is done on conventional guitars. In recognition of this fact some dobros now have solid, so called square necks. Square necks save a little time in manufacturing but cause no effect on performance. Therefore a logical alternative to improve the dobro is to do what this invention is doing. The extended soundbox enhances sound and provides a mounting place for the fret position locator board. The varied use of the fret locator boards has several advantages over the conventional neck and fingerboard. Being able to have all the major keys clearly defined by the simple act of changing fret locator boards, or turning them over is a distinct advantage.

This invention is an acoustic guitar of the Dobro guitar class and it has a conventional soundox, but in place of a neck, as a conventional dobro has, a hollow extended soundbox with an open end that attaches to the soundbox and leaves a hollow unobstructed opening into the soundbox. The other end of the extended soundbox is enclosed at its attachment to the head and the head is conventional with conventional tuning machines. This instrument has no neck, no fingerboard, no frets and no truss rod. Instead of a fingerboard it has fret position locator boards, instead of frets, lines across the board serves the same purpose as frets. This board also shows locations of different chords in given keys. The fret position locator boards are changeable and different boards have different keys shown on them and they may have different keys shown on the opposite side. They can be turned over by removing the attachment means and re-attached after the board has been turned over or replaced by a different fret position locator board. A board that has more than one key shown on it may have the different keys color-coded to clearly define the different keys. A logical way to color-code is to add the desired color to the background in the circles that show the different chords in a key. See FIG. 3 of the drawing. The hollow extended soundbox enhances the sound and provides a mounting place for a fret position locator board.

A different version of this invention is realized when a fret position locator board is placed under the strings of a conventional guitar to convert it to a temporary dobryan. By replacing the nut with a nut that raises the strings and after tuning it like a dobro, a person can have a makeshift dobryan with little cost to learn to play on. The fret position locator boards of this invention, makes all of the major keys easy to find and identify. The dobryan player will have the option of having three keys located on one side and four located on the other side and color coded as explained. This combination will give all seven major keys on one board. The boards are easy to replace or turn over by removing the attachment and it can be replaced easily after the change.

### BRIEF SUMMARY OF THE INVENTION

The dobryan guitar of this invention is a logical improvement over the conventional dobro because the extended soundbox enhances sound, it is easier to build than a neck, it is easier to attach to the main soundbox, a carved neck is not needed and there is no need for a truss rod to keep a neck from warping. There are no frets to install. Playing this new type guitar is easier because all seven of the major keys are more clearly defined. It was not my intention to apply for a patent when I decided to build this invention, but it turned out to be so good that I decided to apply for a patent. Some musicians play the dobro only in the key of G and here is the reason why a steel bar across the strings at the 12^{th} gives the chord of G. The open strings are G one octave lower the fifth fret is C and the 7^{th} fret is D that makes up all the major chords in the key of G. These positions have a mother of pearl maker on the fingerboard and these markers are standard on all guitars. No other key is so convenient on conventional dobros.

### BRIEF DESCRIPTION OF THE DRAWING

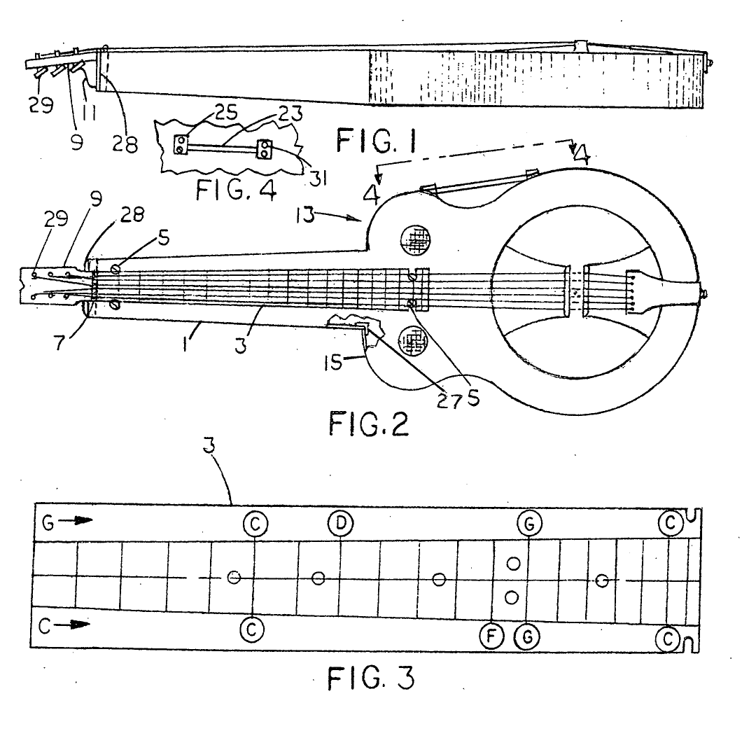

This invention will be better understood by reference to the accompanying drawings wherein FIG. 1 is a left side view of a preferred embodiment of the stringed musical instrument of this invention with a fret position locator board on top of the extended soundbox. The extended soundbox is positioned where the neck of a conventional dobro would be if this were a conventional dobro. FIG. 2 is a plan view of the stringed musical instrument of this invention illustrated in FIG. 1. FIG. 3 is a plan view of a fret position locator board, shown in a larger scale, that locates fret positions with lines drawn across the board in place of frets and the board also shows the location of chord positions that make up the key of G on the upper-half of the board and chords that make up the key of C on the lower-half of the board. This is an example of how the different fret locator boards will show the different keys. FIG. 4 is a fragmentary view of the right side of the soundbox taken along lines 4-4 of FIG. 2 and is showing a handle. A handle is unusual on a guitar but it is necessary on this invention to permit lifting the instrument with one hand because it has no neck that can be grasped with one hand.

### DETAILED DESCRIPTION OF THE INVENTION

Referring initially to FIGS. 1-4 of the drawing, the stringed musical instrument of the dobryan guitar with soundbox extension hereinafter referred to as the musical instrument of this invention is generally illustrated by reference numeral 13 and is provided with a soundbox extension channel 1 which enhances the sound quality of the musical instrument of the invention. The extended soundbox being an open channel simply emits more resonation than the solid neck does on the conventional dobro and I found this to be true the first time I played this instrument with soundbox extension of this invention after I built it. The extended soundbox 1 is an open channel, it is tapered and the largest end is attached to the front end of the soundbox 15 with a bracket 27 that permits an unobstructed opening into the main soundbox 15. The smaller end terminates at fitting 28 where it attaches to the head 9. The head is conventional with conventional tuning machines 29. Attachment of the head 9 is reinforced by bracket 11. A fret locator marker board 3 is placed on top of extended soundbox 1. The fret locator marker board 3 is attached to the extended soundbox 1 with four screws 5. The marker board can be easily removed by removing one of the four screws 5 which is to be replaced after turning the board over to show keys on the opposite side or replace the board with a board that has different keys shown on it. A conventional nut 7 is located at the front end of the fret marker board 3. Referring now to FIG. 4 of the drawings a handle 23 is attached to the right side of the instrument of this invention with brackets 25 and screws 31, the handle 23 permits grasping and lifting this instrument with one hand.

What I claim as my invention is:

1. A stringed musical instrument that is named dobryan and is of the type that is played by using a steel bar for noting and the soundbox is equipped with a standard resonator and in place of a neck, a hollow extended soundbox attaches to the front end of the soundbox leaving an unobstructed opening into the soundbox and it extends forward and attaches to a conventional head and the extended soundbox is closed where it attaches to the head and the instrument has fret location marker boards that have lines drawn across them in place of frets and they have one or more keys shown on them and the different keys are color coded to give quick and easy recognition and a fret location marker board is mounted on top of the extended soundbox under the strings in place of a fingerboard and the fret marker board has chords located on it that make up the chords of selected keys and the boards are removable and therefore interchangeable, permitting the display of any desired key and the soundbox is rounded on the aft end and has the same center as the resonator and the front portion of the soundbox has a sound hole on each side on top and rounded portions that have the same centers as the sound holes.

2. A stringed musical instrument as set forth in claim 1 wherein the instrument is the same as claimed in claim 1 except it has no resonator but in place of a resonator it has a conventional round sound hole located at the center of the rounded aft section.

3. A fret location marker board that has one or more keys located on it with lines drawn across the board in place of frets and the chords that make up a chosen key are color coded for quick and easy recognition to aid in playing the dobryan guitar when placed under the strings.

4. A guitar with a conventional dobro type soundbox and it has a hollow extended soundbox in place of a neck that attaches to and extends forward from the main soundbox to where it attaches to a conventional head and a handle is provided on one side of the instrument to permit handling the instrument with one hand.
